(19) United States
(12) Patent Application Publication
(10) Pub. No.: US 2006/0095210 A1
(43) Pub. Date: May 4, 2006

(54) Weather station

(75) Inventor: Raymond Chan, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: IDT Technology Limited, Hunghom (HK)

(21) Appl. No.: 10/968,054

(22) Filed: Oct. 20, 2004

(51) Int. Cl. G01W 1/00

(52) U.S. Cl. 702/3; 340/601; 73/170.16

(57) ABSTRACT

A weather station for measuring and indicating weather conditions, comprises a casing having a display and an electronic operating circuit in the casing for operation. The operating circuit has sensors for sensing atmospheric parameters e.g., temperature, pressure, and humidity, and a memory storing literal weather messages pertinent to the atmospheric parameters. Also included is a control unit programmed to determine degrees of the atmospheric parameters sensed by the sensors and then to retrieve weather messages corresponding to the degrees and display the messages on the display.

The present invention relates to a weather station for indicating weather conditions.

### BACKGROUND OF THE INVENTION

Weather stations (or monitors) for indicating weather conditions are generally known, which may incorporate other functions or be included as part or a function of an equipment of another type and in particular a clock. Weather conditions, such as temperature and weather forecast, are typically indicated by the measured values or pertinent symbols on an LCD display. These manners of indication are sometimes found to be not practical or inadequate.

The invention seeks to obviate or at least alleviate such shortcoming by providing a new or improved weather station.

### SUMMARY OF THE INVENTION

According to the invention, there is provided a weather station for measuring and indicating weather conditions, comprising a casing having a display and an electronic operating circuit in the casing for operation. The operating circuit comprises at least one sensor for sensing an atmospheric parameter, a memory for storing at least one literal weather message pertinent to the atmospheric parameter, and a control unit for determining degree of the atmospheric parameter sensed by the sensor and retrieving a said weather message corresponding to the degree and then displaying the weather message on the display.

Preferably, the control unit is adapted to display the weather message on the display in a dynamic manner.

More preferably, the display extends horizontally and the control unit is adapted to display the weather message scrolling along the display.

Advantageously, the display comprises a dot matrix display.

It is preferred that the memory stores a plurality of literal weather messages corresponding to variations of the atmospheric parameter for display on the display under the control of the control unit according to the corresponding variations as determined.

It is preferred that the or each weather message has a content that indicates at least one of probable weather phenomenon, probable effect on a person and action recommended to a person.

Preferably, the memory stores a plurality of literal weather messages of different types comprising heat index, UV index and weather forecast.

More preferably, the message types include freeze, ice and fog alerts.

It is preferred that the atmospheric parameter comprises temperature expressed as heat index having a series of variations, and the memory stores a plurality of literal weather messages corresponding to the variations, having contents indicating probable effects on a person, for display on the display under the control of the control unit according to the corresponding variations as determined.

It is preferred that the atmospheric parameter comprises UV solar radiation expressed as UV index having a series of variations, and the memory stores a plurality of literal weather messages corresponding to the variations, having contents indicating actions recommended to a person, for display on the display under the control of the control unit according to the corresponding variations as determined.

It is preferred that the atmospheric parameter comprises pressure trend expressed as weather forecast having a series of variations, and the memory stores a plurality of literal weather messages corresponding to the variations, having contents indicating probable weather phenomena, for display on the display under the control of the control unit according to the corresponding variations as determined.

It is preferred that the atmospheric parameter comprises temperature and humidity expressed as one of freeze, ice and fog alerts, and the memory stores a corresponding literal weather message, having a content indicating one of action recommended to a person and probable weather phenomenon, for display on the display under the control of the control unit according to the temperature and humidity as determined.

Preferably, the memory stores a plurality of literal weather messages of different types, and the control unit is programmed to display the weather messages on the display sequentially according to their types in a predetermined order.

More preferably, the control unit is programmed to display the weather messages repeatedly and continuously, and a key of the operating circuit is operable to reset the display to restart from a weather message of a warning nature.

Advantageously, the control unit is programmed to display the weather message or messages on the display repeatedly and continuously for reading at any time.

### BRIEF DESCRIPTION OF DRAWINGS

The invention will now be more particularly described, by way of example only, with reference to the accompanying drawings, in which:

FIG. 1 is a front elevational view of an embodiment of a weather station in accordance with the invention, said station having a display;

FIG. 2 is a left side elevational view of the weather station of FIG. 1;

FIG. 3 is a schematic view of a series of messages displayed on the display of FIG. 1; and

FIG. 4 is a schematic functional block diagram of an operating circuit of the weather station of FIG. 1.

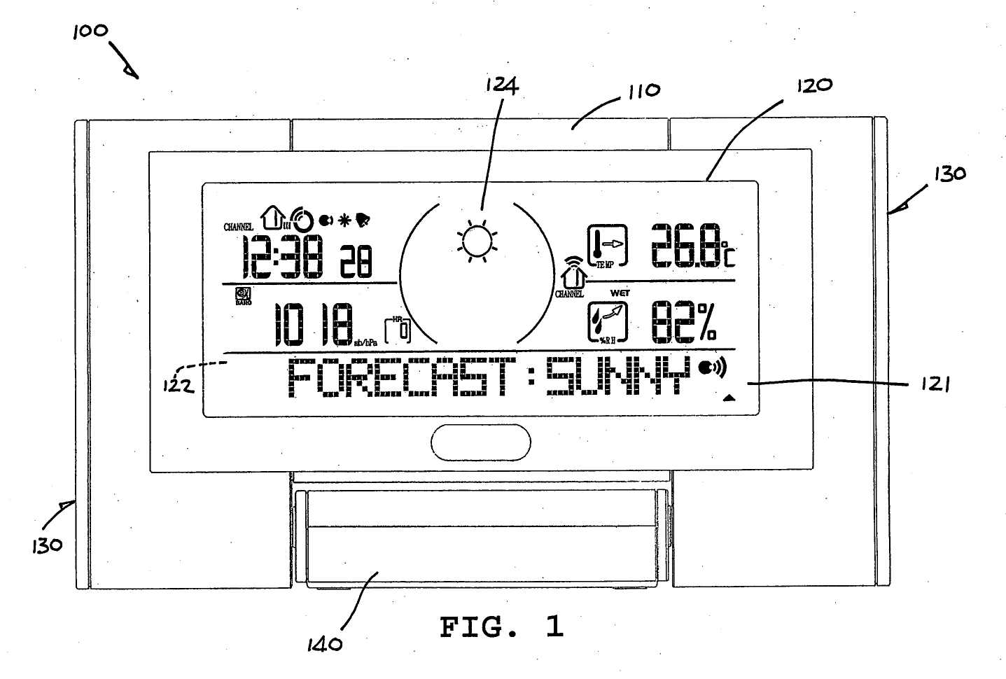

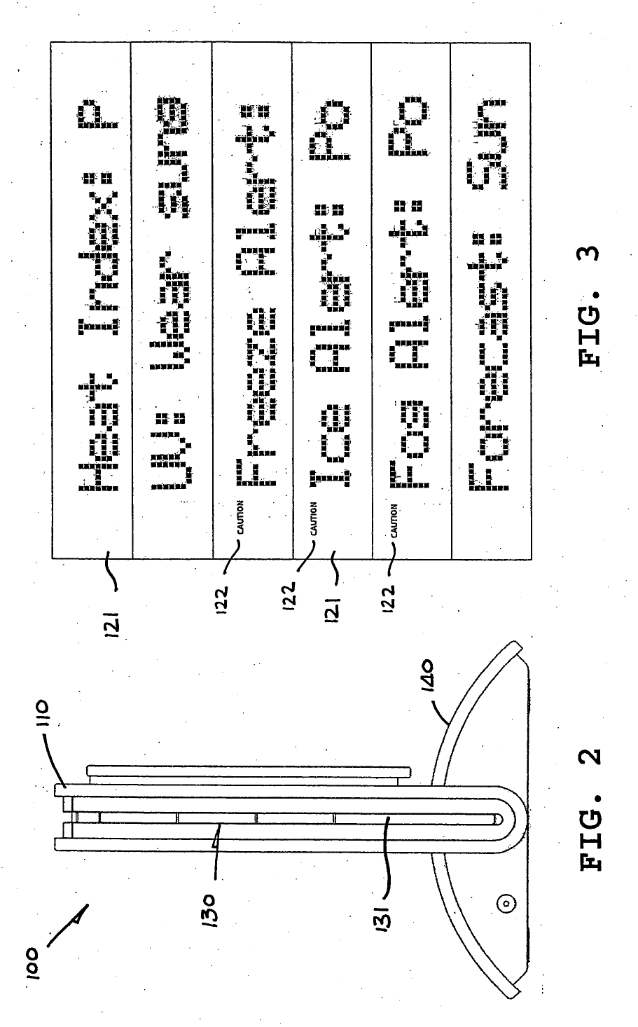

### DETAILED DESCRIPTION OF PREFERRED EMBODIMENT

Referring to the drawings, there is shown a desktop weather station 100 embodying the invention, which comprises a flat rectangular casing 110 having an LCD display 120, nine function keys 130 on opposite left and right sides thereof including a message key 131, and a snooze/light button 140 on a stand below the display 120. The bottom part of the display 120 is manufactured as an oblong dot matrix display 121 which extends horizontally and is dedicated to display of weather messages.

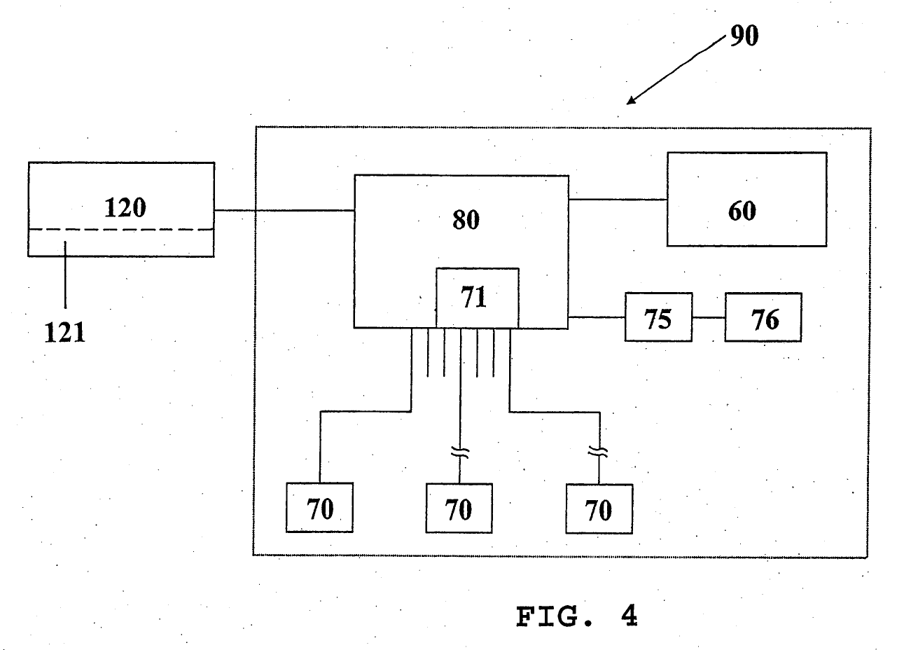

An electronic operating circuit 90 (FIG. 4) in the casing 110 measures various atmospheric parameters for indicating weather conditions and provides time/calendar information on the display 120. Such atmospheric parameters comprise barometric pressure, temperature and humidity and weather forecast is also included, all of which are collectively referred to as weather conditions.

The operating circuit 90 includes a control unit built based upon a microprocessor 80 to perform various weather and clock functions. For weather functions, the microprocessor 80 is programmed and calibrated to process various weather input signals and perform relevant computations and then provide appropriate outputs for display on the display 120 in various modes. For clock functions, a built-in radio-controlled clock module 75 of the operating circuit 90 provides time and calendar information as well as an alarm. There is also included a radio-frequency (RF) clock sensor 76 for automatic synchronization with the RF time and calendar signals broadcast by the local authority of the country or time zone concerned for official time synchronization.

The operating circuit 90 includes a plurality of sensors 70 for sensing the various weather parameters, such as temperature, pressure and humidity in particular. Some of these sensors 70 are wired within the station casing 110 for indoor measurement of temperature for example, whilst the others are remote thermo-hygro sensors 70 placed at suitable outdoor locations for measuring temperature and humidity. A receiver 71 of the operating circuit 90 provides up to five RF communication channels for receiving input signals from respective remote sensors 70, whose transmitters are tuned to the right channels.

Indoor temperature is measurable in the range from −5° C. to +50.0° C. (23° F. to 122.0° F.) and outdoor (remote) temperature from −20.0° C. to +60.0° C. (−4.0° F. to +140.0° F.). Both indoor and outdoor humidity can be measured in the range from 25% to 95%.

Barometric pressure can be measured and displayed numerically in mb/hPa or in Hg as selected by a user. Altitude adjustment is built-in for automatic atmospheric pressure compensation from −100 m to 2500 m.

It is known that the trend of change in atmospheric pressure provides a reasonably reliable basis for ascertaining the current weather condition and predicting the forthcoming weather condition. Intensive research and analysis including statistical studies on this topic have been conducted, and various algorithms derived for use in weather forecast. In this regard, the microprocessor 80 is programmed based on an appropriate algorithm to identify five variations of weather forecast conditions, namely Sunny, Partly Cloudy, Cloudy, Rainy and Snowy, and to indicate them using respective sun/moon, cloud, rain and snow kinetic icons 124 on the display 120.

The first four conditions are determined primarily according to the variations in atmospheric pressure as measured by the relevant sensor 70 every fifteen minutes over a certain past period of time for at least several hours. Such pressure variations or trend includes, for example, the rate of rise or fall and the relative level as between the highest and lowest measurements. Identifying the SNOW condition also requires the use of rain and thermal sensors 70.

The weather station 100 is capable of displaying on the dot matrix display 121 weather messages in literal form pertinent to the atmospheric parameters or conditions, based on their degree, level or values, as measured by the sensors 70 and microprocessor 80. The word contents of the messages are stored in the microprocessor's internal registers or a ROM memory 60 as part of the operating circuit 90, for retrieval and display whenever appropriate.

There are six different types of weather messages: Heat Index, UV Index, Frost/Freeze, Ice Warning, Fog and Weather Forecast, and each type may include one or more messages, whose definition and content are set out in the following table:

| Message Type | Definition | Message Content |
|---|---|---|
| Heat Index | 26.7° C.-32.2° C. | Possibility of heat |
| | (80° F.-90° F.) | exhaustion |
| | 32.2° C.-40.5° C. | Strong heat - Possibility |
| | (90° F.-105° F.) | of dehydration |
| | 40.5° C.-54.4° C. | Very strong heat - Heat |
| | (105° F.-130° F.) | exhaustion likely |
| | 54.4° C./130° F. or | Intense heat - Strong |
| | greater | possibility of heat stroke |
| UV Index | 0-2 | UV: Apply sunscreen |
| | 3-5 | UV: Wear protective |
| | | clothing |
| | 6-7 | UV: Wear sunglasses & |
| | | protective clothing |
| | 8-10 | UV: Avoid the sun between |
| | | 10AM to 4PM |
| | >=11 | UV: Very strong rays stay |
| | | indoors |
| | UV down count | UV: Time is Up! (max. time |
| | time's up | of exposure to sun is up) |
| Frost/Freeze | Dew point & | Freeze Alert: Wrap pipes & |
| | current temp. | cover your vegetation |
| | <=0° C./32° F. | |
| Ice Warning | −2° C. to 3° C. | Ice Alert: possibility of |
| | (28.4° F.-37.4° F.) | black ice when driving |
| Fog | Temperature - | Fog Alert: possibility of |
| | Dew point <−15° C./ | poor visibility when |
| | 5° F. | driving |
| Weather | (Based on trend | Forecast: Sunny - Enjoy |
| Forecast | of variation in | your day |
| | the atmospheric | Forecast: Partly cloudy |
| | pressure) | Forecast: Cloudy |
| | | Forecast: Rainy - Don't |
| | | forget your umbrella |
| | | Forecast: Snowy |

Heat index in general is determined by temperature as the principal atmospheric parameter, supplemented by humidity that being a factor as it affects how environmental heat is felt by the skin. The present Heat Index message type has a series of four variations for hot conditions, which are defined primarily by respective ranges of temperature values. The memory 60 stores separate literal weather messages corresponding to these variations, each having a relevant content for display to foretell a probable harmful effect, i.e. heat exhaustion, hydration or stroke, on a person in the specific hot environmental condition concerned.

The ozone layer shields the Earth from harmful UV (ultraviolet) radiation emitted by the sun. Ozone depletion, as well as seasonal and weather conditions, cause different amounts of UV radiation to reach the Earth at any given time. UV index in general predicts the next day's ultraviolet radiation levels on a 1 to, 11+ official scale.

The subject UV Index is divided into a series of five possible variations in UV radiation, which are defined according to rising levels of the official UV index, and one hostile state i.e. down count time's up state when the maximum time of exposure to the sun has expired. The memory 60 stores separate literal weather messages corresponding to these conditions, each having a related content for display to recommend a suitable protective action, i.e. wearing sunglasses, etc or avoiding the sun, on to a person in that sun condition.

Each of the types Frost/Freeze, Ice Warning and Fog has only one single message that represents an alert signal for a respective adverse state of condition determined based on the temperature and/or humidity (dew point) as set out. Upon reaching of this state, a corresponding literal weather message retrieved from the memory 60 will be displayed to recommend a precautionary action to take for Frost/Freeze or to suggest a specific weather phenomenon likely to meet for Ice Warning or Fog i.e. black ice or poor visibility respectively.

With regard to the message type on Weather Forecast, there are the five variations, i.e. Sunny, Partly Cloudy, Cloudy, Rainy and Snowy by name, defined based on the trends in atmospheric pressure. Corresponding literal weather messages stored in the memory 60 have content for display to predict the probable general weather phenomenon or condition by those names.

In general, a weather message will be displayed if, and for as long as, the criteria of the associated definition are met i.e. those atmospheric parameters are prevailing. The exceptions are the Weather Forecast and UV Index messages, which will always be exhibited as each set of messages covers all possible variations.

On the dot matrix display 121, each message will be displayed in a dynamic manner for prominence or to be eye-catching. This can be done in a number of ways, for example the message can be made to flash or be displayed on a blinking background or, as in the case of the described embodiment, the message is displayed as a single line sentence scrolling from right to left along the display 121, as depicted in FIG. 3 which shows the start of every message content sentence.

The Heat Index and UV Index messages for the last two variations of either type and the message of each type Frost/Freeze, Ice Warning or Fog are classified by their nature as warning messages (shown in italic in the table), whilst the remainders are general message of the other kind. The warning messages are always accompanied by a stationary icon “CAUTION” 122 positioned at the upper left corner of the display 121 for enhanced conspicuousness.

The messages on show are normally displayed sequentially and repeatedly in the cyclic order according to their types: Warning (Frost/Freeze, Ice Warning and/or Fog)>Weather Forecast>Heat Index>UV Index>Warning, etc. As the messages are displayed continuously, they can be read at any time. Upon pressing of the message key 131, the cyclic display will be reset to restart from the warning messages and, upon repeated pressings, to scroll down to a specific message type as desired so that the message of that type can be read immediately.

The weather station 100 has a number of operation modes that can be entered or exited, or in general selected, using appropriate keys 130 as is generally known in the art. There are three principal operation modes namely clock/alarm, temperature/humidity and pressure/UV display modes, which can be switched to subsidiary modes for inter alia setting the clock/alarm or displaying further information e.g. temperature/humidity history and their maximum/minimum values or pressure/UV.

The invention has been given by way of example only, and various other modifications of and/or alterations to the described embodiment may be made by persons skilled in the art without departing from the scope of the invention as specified in the appended claims.

1. A weather station for measuring and indicating weather conditions, comprising:
an casing having a display; and
an electronic operating circuit in the casing for operation, the operating circuit comprising:
at least one sensor for sensing an atmospheric parameter,
a memory for storing at least one literal weather message pertinent to the atmospheric parameter, and
a control unit for determining degree of the atmospheric parameter sensed by the sensor and retrieving from the memory a weather message corresponding to the degree and displaying the weather message retrieved on the display.

2. The weather station as claimed in claim 1, wherein the control unit displays the weather message on the display in a dynamic manner.

3. The weather station as claimed in claim 2, wherein the display extends horizontally and the control unit displays the weather message scrolling along the display.

4. The weather station as claimed in claim 1, wherein the display comprises a dot matrix display.

5. The weather station as claimed in claim 1, wherein the memory stores a plurality of literal weather messages corresponding to variations of the atmospheric parameter for display on the display under control of the control unit.

6. The weather station as claimed in claim 1, wherein each weather message has a content that indicates at least one of probable weather phenomenon, probable effect on a person, and action recommended to a person.

7. The weather station as claimed in claim 1, wherein the memory stores a plurality of literal weather messages comprising heat index, UV index, and weather forecast.

8. The weather station as claimed in claim 7, wherein the messages include freeze, ices and fog alerts.

9. The weather station as claimed in claim 1, wherein the atmospheric parameter comprises temperature expressed as a heat index having a series of variations, and the memory stores a plurality of literal weather messages corresponding to the variations, having contents indicating probable effects on a person, for display on the display under control of the control unit.

10. The weather station as claimed in claim 1, wherein the atmospheric parameter comprises UV solar radiation expressed as a UV index having a series of variations, and the memory stores a plurality of literal weather messages corresponding to the variations, having contents indicating actions recommended to a person, for display on the display under control of the control unit.

11. The weather station as claimed in claim 1, wherein the atmospheric parameter comprises pressure trend expressed as a weather forecast having a series of variations, and the memory stores a plurality of literal weather messages corresponding to the variations, having contents indicating probable weather phenomena, for display on the display under control of the control unit.

12. The weather station as claimed in claim 1, wherein the atmospheric parameter comprises temperature and humidity expressed as one of freeze, ice, and fog alerts, and the memory stores a corresponding literal weather message, having a content indicating one of action recommended to a person and probable weather phenomenon, for display on the display under control of the control unit according to the temperature and humidity determined.

13. The weather station as claimed in claim 1, wherein the memory stores a plurality of literal weather messages and the control unit is programmed to display the weather messages on the display sequentially, in a predetermined order.

14. The weather station as claimed in claim 13, wherein the control unit is programmed to display the weather messages repeatedly and continuously, and a key of the operating circuit is operable to reset the display to restart from a weather message of a warning nature.

15. The weather station as claimed in claim 1, wherein the control unit is programmed to display the at least one weather message on the display repeatedly and continuously for reading at any time.
